(19) United States
(12) Patent Application Publication
(10) Pub. No.: US 2010/0252783 A1
(43) Pub. Date: Oct. 7, 2010

(54) AMBIENT-CURABLE ANISOTROPIC CONDUCTIVE ADHESIVE

(76) Inventor: Syh-Tau Yeh, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/419,303

(22) Filed: Apr. 7, 2009

(51) Int. Cl. H01B 1/22

(52) U.S. Cl. 252/513; 252/500

(57) ABSTRACT

Compositions of ambient-curable anisotropic conductive adhesive comprising an ambient-curable epoxy resin system and a conductive powder are proposed. It can be cured under ambient conditions using common magnet for clamping mechanism. This greatly simplifies many electronic repairs or Do-It-Yourself types of application. This anisotropic conductive adhesive can also be applied using traditional hot-bar laminator, but at lowered temperatures, and this is bound to open up new application possibilities.

### BACKGROUND OF THE INVENTION

1. Field of the Invention

The present invention relates to an anisotropic conductive material. More particularly, the present invention relates to a composition of an electrical anisotropic conductive adhesive that is curable under ambient condition.

2. Description of the Prior Art

As propelled by consumer preferences, electronic products have become smaller in size, lighter and more compact. It is also required that the electronic products are able to process more information at higher speeds. Consequently, electronic product manufacturers are facing the issue of having to connect electric components at ever increasing precisions.

Although the traditional method of soldering has been proven to be fairly reliable and easy to operate, it has troubles with connecting circuit parts at very fine pitches. Different anisotropic conductive materials, such as anisotropic conductive film (ACF) or anisotropic conductive paste (ACP) have all found some success in resolving this issue, but they also have some drawbacks.

An anisotropic conductive film typically consists of conductive particles, such as gold-plated resin particles, dispersed in a thermosetting latent-curing epoxy resin system. Electricity is conducted through the conductive particle and freely flows between the two substrates, but not along the anisotropic conductive film because the conductive particles are sparsely dispersed to avoid contact with each other. ACF is typically supplied as a roll of thin film backed by a release liner. The applications of ACF involve two steps. In the first step, the ACF together with the release liner is attached to the first substrate through a hot-bar pre-lamination step which takes place at a temperature of around 100° C. The release liner is removed right after pre-lamination to expose the ACF surface. This ACF-attached substrate is then moved to a second hot-bar to complete the final positioning and lamination process with the second substrate. The final hot-bar lamination is generally carried out at a relatively high temperature of 160-220° C. This process is almost fully automatic in the assembly of TFT-LCD panel. Its reliability has also been well proven. Despite this commercial success, however, attempts of applying ACF to other electronic assembly applications, such as the attachment of FPCB (Flexible Printed Circuit Boards) to rigid PCB (Printed Circuit Boards), have not shown any significant success mainly because the substrate surface flatness tends to be no as uniform.

The relatively high lamination temperature of ACF is also a hindering factor for it to become more popular. This relatively high lamination temperature can cause substrate shrinkage especially in the touch-panel assembly where PET-film based substrate can cause unwanted shrinkage. This problem is not easy to resolve because it is supplied in the form of a dry film which contains a slow-reacting one-component latent curing system. As such, it needs to be stored in a refrigerated state so that a reasonable shelf life can be achieved. However, this slow-reacting curing system also prevents it from attaining the desired degree of curing in a relatively short time under normal curing conditions. To overcome this problem, the lamination temperature has to be raised to above 180° C. to shorten the curing process. This limits its usage to substrates that are not heat tolerant. A good example of that is PET film substrate which is used in touch-panels or futuristic flexible display panels.

ACP can compensate some of ACF shortfalls, i.e. it can still function when substrate flatness is not as uniform. For that reason, it has been used successfully for applications such as the connection of FPCB (Flexible Printed Circuit Boards) to rigid PCB (Printed Circuit Boards). ACP is usually supplied as screen-printable liquid paste. It is applied to the substrate surface via screen printing followed by a brief drying at elevated temperature, which is usually around 100° C. to remove the solvent so that a non-tacky surface is exposed after the drying process. Hot-bar is then used for positioning and heat-lamination of the connecting substrate. The lamination temperature of ACP is also lower than that of ACF, as It can be operated at 140° C. However, its viscosity is relatively high, which makes screen-printing difficult and coating quality problematic. Its lamination temperature, although lower than that required of ACF, is still relatively high, i.e. above 140° C. This limits its utilization in the application of touch-panel assembly.

In view of this, a new type of anisotropic conductive adhesive (ACA) is proposed by this inventor to resolve the above-mentioned problems. A two-part anisotropic conductive liquid adhesive formulation that is capable of being cured under ambient conditions is revealed. Plainly put, it is just a mixture of electrically conductive particles with a two-part epoxy adhesive system consisting of epoxy resin(s) and ambient curing hardener(s). The conductive particle can be of fine filamentary powder, flake nickel powder, gold-plated resin particle, or fine filamentary copper powders. The epoxy resin can be any liquid epoxy resin such as bisphenol-A, bisphenol-F, novolak, flexibilized epoxy resin, or mixture of those epoxy resins. As for the hardener, modified amines have been found to do well for this purpose.

This new type of ACA can be simply applied to the substrate surface by hand just like any regular two-part epoxy adhesive. After attaching the other connecting substrate on top of the first substrate, the assembly is placed on top of steel surface and a magnet is placed on top of the substrate assembly to clamp it down so that close contact can be maintained throughout the ambient-curing process. The magnet can also server the purpose of aligning magnetic particles such as nickel powders to achieve better anisotropic conductivity. This application method does not involve any equipment, and is very convenient for electronic DIY assembly. In addition to the ambient-curing method using magnet for clamping, it can also be applied with common hot-bar laminator. The hot-bar lamination provides more speedy and reliable connection. Compared with using existing commercial ACF or ACP, this product excels in versatility, i.e. it can be laminated over a much wider temperature range which is from 80-150° C. This allows it to be used for flexible transparent substrate such as those used in touch-panels or flexible display panels.

U.S. Pat. No. 7,077,659 B2 filed Jul. 18, 2006 to Weiss et al. discloses an anisotropic conductive sheet obtained by mixing magnetic particles with a liquid resin, forming the mix into a continuous sheet and curing the sheet in the presence of magnetic field. This results in particles forming columns through the sheet thickness which are electrically conductive.

U.S. Pat. No. 7,071,722 B2 filed Jul. 4, 2006 to Yamada et al. discloses another anisotropic conductive sheet with slightly larger magnetic conductive particles (5-50 μm average diameter). The conductive particle is such as iron, nickel, cobalt, or composite particles obtained using nickel as core particles and plating the surfaces with gold or silver. The conductive particle was mixed with liquid silicone rubber containing proper curing reagents. The anisotropic conductive rubber sheet is formed using a sheet-mold in the presence of heat and strong magnetic field.

U.S. Pat. No. 6,849,335 B2 filed Feb. 1, 2005 to Igarashi et al discloses a molding compound containing magnetic conductive particles of slightly smaller particle sizes (1-10 μm average diameters) and a liquid silicone rubber was sheet molded simultaneously under heat and magnetic fields.

U.S. Pat. No. 6,669,869 B2 filed Dec. 30, 2003 to Yamaguchi et al. discloses winding a copper wire coated with an insulating polymer into a anisotropic conducting block of multiple winding layers, and then sliced the block into thin layers of anisotropic conducting sheet.

U.S. Pat. No. 6,878,435 B2 filed Apr. 12, 2005 to Paik et al. reveals a triple-layered anisotropic conductive adhesive film based on the above-mentioned concept of sparsely dispersed conductive particles. The triple-layered configuration is meant to enhance the adhesion of ACA film. Therefore two adhesion reinforcement layers are added to the top and bottom surfaces of the main ACA film. The main ACA film is 25-50 μm in thickness, having 5-20% by weight of conductive particles of 3-10 μm in particle diameter. The adhesion reinforcement layers containing 5-10% by weight of conductive particles are 1-10 μm thick.

U.S. Pat. No. 6,939,431 B2 filed Sep. 6, 2006 to Mizuta et al. discloses an anisotropic conductive paste composition. Conductive particles made of noble metals such as gold, nickel, silver or platinum, and organic fine particles coated by nickel and gold are examples. Thermosetting resin consisting of an epoxy resin with acid anhydride and phenolic resin as curing agent, plus appropriate catalyst, de-foamer and other necessary additives formed the base polymer. High softening point particles of acrylates and silicone elastomer are added. The weight of conductive particles is 2-15% of the total weight, and is only 5% of the total weight in most of the examples.

U.S. Pat. No. 6,838,022 B2 filed Jan. 4, 2005 to Khanna discloses an anisotropic conductive compound comprising magnetic conductive particles, such as nickel, blended with thermosetting epoxy resin. This compound needs to be thermally cured under a magnetic field. Pre-sealing by a UV-curable resin is required. The disclosed procedures are not practical.

U.S. Pat. No. 6,827,880 B2 filed Dec. 7, 2004 to Ishimatsu discloses an anisotropic conductive adhesive consisting of peroxide-cured vinyl ester resin compound and conductive particles, which is claimed to have good adhesion and environmental durability.

U.S. Pat. No. 6,812,065 B1 filed Nov. 2, 2004 to Kitamura discloses an anisotropic conductive paste consisting of a conductive particle having a specific size, a thermosetting epoxy resin, a rubber particle and a high softening point polymer particle.

### SUMMARY OF THE INVENTION

It is one object of the present invention to provide an anisotropic conductive adhesive that can be cured under ambient condition.

According to the claimed invention, a composition of anisotropic conductive adhesive comprises an ambient-curable epoxy resin system consisting of an epoxy resin and an ambient-curable hardener; and a conductive particle which can be filamentary nickel powders or fine nickel flakes. The conductive powder which is uniformly dispersed in the epoxy adhesive with a weight percentage of 1-10%. The conductive particle plays the role of forming electrical contact, while the epoxy resin binds substrates together.

Unlike most of the present commercial anisotropic conductive products which need to be operated at relatively high temperatures, i.e. above 140° C., this invention provides anisotropic conductive adhesive that can be operated at a much lower temperature. It can even be operated under ambient condition. This low-temperature-operable characteristic is very useful for developing many new electronic assembly possibilities.

This invention proposes a composition formed by dispersing fine nickel powders (filamentary or flake) into an ambient curable epoxy resin system, where the epoxy resin system consists of an epoxy resin mixed with ambient-curable hardener. Since this epoxy resin system is very similar to the common two-part epoxy adhesive, its adhesive properties is proven and reliable, the requirement for an anisotropic conductive adhesive to have good adhesion is automatically fulfilled.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 demonstrates reference x-, y- and z-coordinate system and the conductive planes. The upper and lower conductive bumps are denoted as 70 and 71. The upper and lower insulating substrates are denoted as 60 and 61. The anisotropic conductive adhesive denoted as 50 is filled at the gap between upper and lower substrates. Electricity is conducted along bumps 70 and 71 via ACA denoted as 50.

FIG. 2 shows the wiring pattern on RPCB & FPCB. This wiring pattern is used for testing anisotropic conductivities of different ACA compositions. Label 80 denotes square conductive copper pads of 80-mm width. Measurement of electric resistance can be conducted over these copper pads. Parallel conductive copper traces are denoted as 90. Anisotropic conductive adhesive is applied to the area at the bottom edge of 90 on a piece of RPCP (Rigid Printed Circuit Board) then a piece of FPCB (Flexible Printed Circuit Board) of the same wiring pattern is attached.

FIG. 3 is the schematic drawing showing the lamination configuration of FPCB (Flexible Printed Circuit Board) to RPCB (Rigid Printed Circuit Board). Square copper conductive pads are denoted as 80 and parallel conductive copper traces are denotes as 90. RPCB (Rigid Printed Circuit Board) substrate of FR-4 is denoted as 100 and FPCB (Flexible Printed Circuit Board) substrate of polyimide film is denoted as 200.

FIG. 4 shows electric resistances versus trace length for conductive traces extending from FPCB to RPCB. The y-axis intercept represents the true electric resistance of tested anisotropic conductive adhesive.

### DETAILED DESCRIPTION

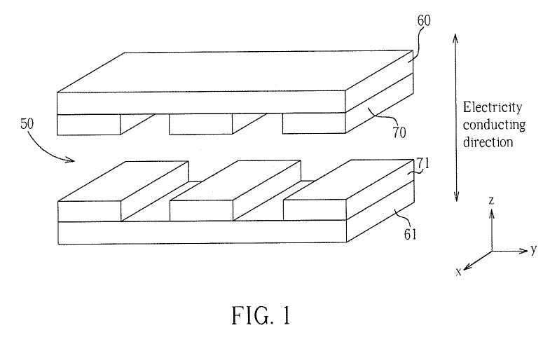

The present invention relates to an anisotropic conductive adhesive that can be cured under ambient conditions. This anisotropic conductive material allows electricity to be conducted only in z-direction (the direction perpendicular to the adhesive film), but not along x- and y- directions (x- and y-directions lie on the adhesive film). The aforesaid reference x-, y- and z-coordinate system and the conductive planes are demonstrated in FIG. 1. As shown in FIG. 1, the anisotropic conductive material (not explicitly shown) is filled between the conductive plane A and conductive plane B with bumps 70 in between.

This ambient-curable anisotropic conductive adhesive consists of a conductive particle uniformly dispersed in a liquid ambient-curable epoxy resin system which comprises of an epoxy resin and an ambient-curable hardener. Filamentary nickel powders have been found to be well suited for this purpose. Their high specific surface areas and porous deformable structures are postulated to be helping factors for enhancing electrical conductivity. Examples of commercially available filamentary nickel powder are Inco® Type 210, 210H, 240 and 255, and examples of commercially available Fine flake nickel powders, although not as effective, can also serve this purpose. Examples of fine flake nickel powders are Inco® HCA-1, Fine Leafing and Fine Leafing Pigment Grade. The amount of conductive powders added is in the range of 1-10% based on the total weight of the mixture.

The ambient-curable epoxy resin consists of a liquid epoxy resin or a blend of liquid epoxy resins with a liquid ambient-curable harder. Common commercially available liquid epoxy resins, such as bisphenol-A, bisphenol-F or flexibilized epoxy resins can be used. Examples of epoxy resins are Dow Chemicals DER 383, DER 351 and DER 324. Many commercially available liquid ambient-curable hardeners, usually of the amine type, can be used. Examples of ambient-curable hardener are Sanho Chemical Kingcure N-768, K-863A and X-963. Other additives, such as defoamer, thixotropic reagent may be added when needed.

Composition examples of ambient-curable anisotropic conductive adhesives are shown in Table 1. These examples illustrate the basic concept of this invention, and are by no means meant to be restrictive. In these examples Ingredients 1-7 are weighed, and then dispersed by a high-speed agitator to form the main component. It is mixed with the hardener right before the coating operation.

TABLE 1

| No. | Ingredients | Example 1 | Example 2 | Example 3 | Example 4 |
|---|---|---|---|---|---|
| 1 | Dow DER 383 | 100.0 | 100 | 85.0 | 85.0 |
| 2 | Dow DER 92466.00 | — | —* | 10.0 | 10.0 |
| 3 | CVC Hypox DA-323 | — | — | 5.0 | 5.0 |
| 4 | Momentive TSA-750S | 0.5 | 0.5 | 0.5 | 0.5 |
| 5 | Degussa Aerosil R970 | 2.5 | 2.5 | 2.5 | 2.5 |
| 6 | Degussa Aerosil A300 | 2.5 | 2.5 | 2.5 | 2.5 |
| 7 | Inco Type 210 | 5.0 | 10.0 | 5.0 | 10.0 |
| | Sum | 110.5 | 115.5 | 110.5 | 115.5 |
| 8 | Truetime 5010 | 100.0 | 100.0 | 100.0 | 100.0 |
| | Sum | 210.5 | 215.5 | 210.5 | 215.5 |
| I | Contact resistance (Ω); 23° C. × 3 | <0.1 | <0.1 | <0.1 | <0.1 |
| | hours using magnet | | | | |
| II | Contact resistance (Ω); 85° C. × 3 | <0.1 | <0.1 | <0.1 | <0.1 |
| | minutes using hot-bat | | | | |
| III | 90°-peel strength (kgf/cm) | >0.5 | >0.5 | >0.5 | >0.5 |

Main component: Ingredients 1-7 are weighed, and then dispersed by a high-speed agitator.
Ingredient 8 is the ambient-curable hardeners. It was mixed with the main component right before application
All are in parts per hundred parts of resin (phr) by weight.

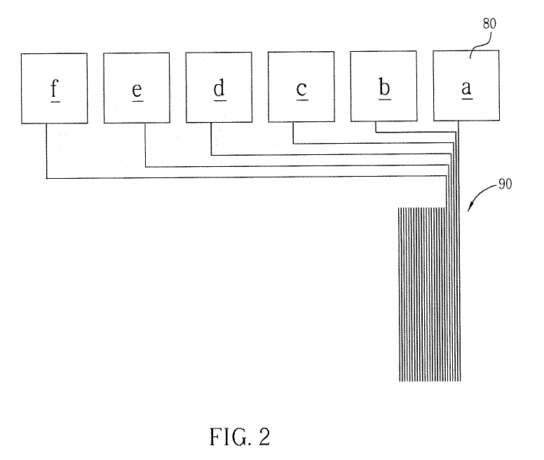

To examine the anisotropic conductivity of the ACA, printed circuit boards of the wiring pattern shown in FIG. 2 were made. The idea of this wiring pattern is to construct parallel conductive trace of 4-mil (100-μm) width and separated by a distance of 8 mils (200 μm), hence the marking of 4/8 on the Figure. This same wiring pattern was applied to make both RPCB (Rigid Printed Circuit Boards using FR-4 as the substrate) and FPCB (Flexible Printed Circuit Boards using polyimide film as the substrate). Six larger conductive square pads 80 of 5-mm×5-mm dimension were connected to the first six conductive traces 90 at the ends so that electric resistance of the conductive trace 90 can be conveniently measured with a common 2-probe electrical multi-meter or the more accurate 4-probe low-resistance meter.

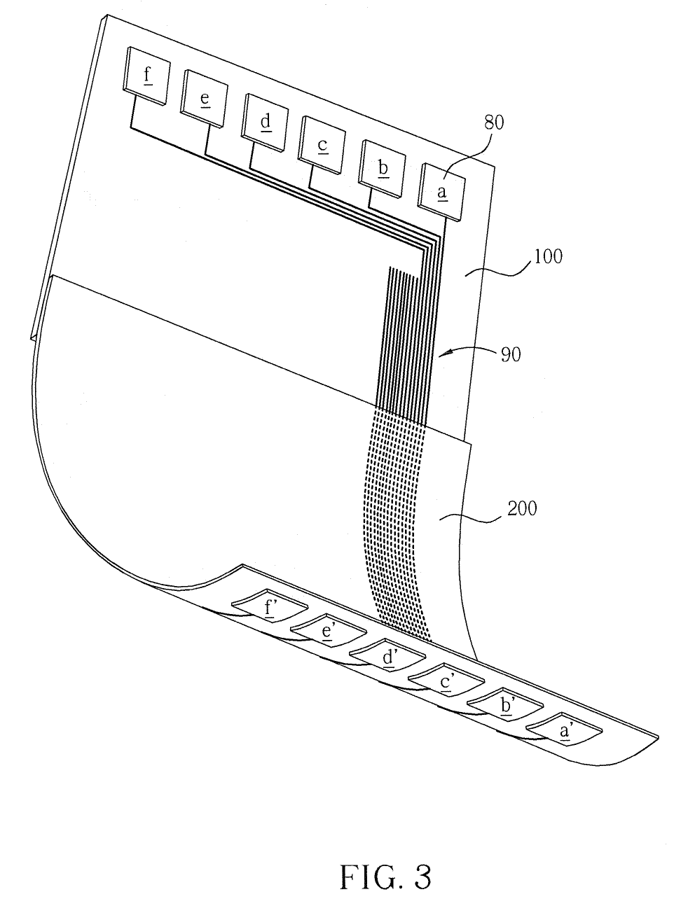

Different ACA compositions were coated onto to the RPCB (Rigid Printed Circuit Boards using FR-4 as the substrate) with wiring pattern of FIG. 2, a FPCB 200 of the same wiring pattern is then placed on top of the RPCB 100, a hot-bar laminator is then used to align the conductive traces 90 on both RPCB 100 and FPCB 200 so that the conductive traces 90 are connected through ACA layer. A schematic of this operation is shown in FIG. 3.

In this experiment, the lamination processes were carried out via two different methods. The first method uses CCD (mounted on the hot-bar) for alignment of the conductive traces, the aligned assembly is then temporarily fixed in position by placing a pressure-sensitive adhesive tape over the joint, the assembly is moved to a flat steel surface, a magnet is then place on the top of the assembly joint to ensure close contact of the two printed circuit boards during the entire ambient curing process, as this generally requires 2-3 hours to complete under ambient condition.

Another method uses hot-bar for alignment and lamination in one step, as is commonly performed with regular ACF or ACP operations. This is carried out at 85° C. for 3 minutes under a pressure of 2,000 Newton over a square area of 2 mm×7 mm. The hot-bar lamination generally gives better and more consistent results.

After lamination, the electrical resistance of separate conductive traces can be measured over the corresponding pads on RPCB and FPCB by folding FPCB over so that the conductive pads on FPCB can be next their corresponding conductive pads on the RPCB. In this configuration, measurement of the electrical resistance of the conductive traces between two corresponding pads (one on RPCB and the other on FPCB) can be easily carried out.

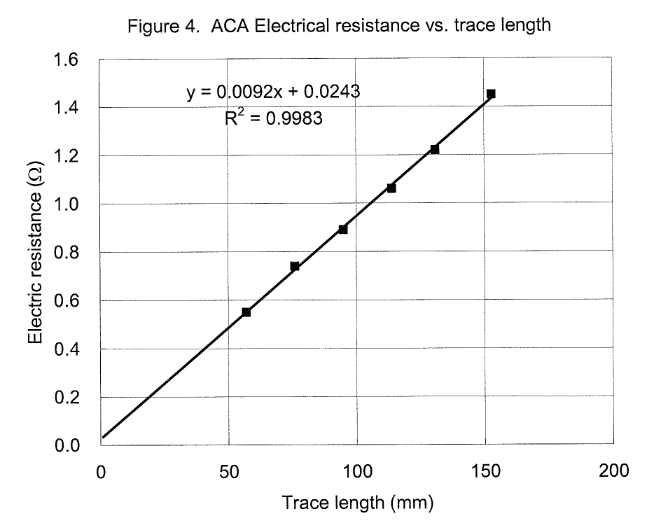

Using the 4-probe low-resistance meter (Mitsuibishi Chemical Loresta-EP MCP T360) for more accurate resistance readings, a typical result is shown in Table 2. In this Table, the first column denoted as: a-a′, b-b′, c-c′, d-d′, e-e′ and f-f′ represents those 6 pairs of square pads from right to left, where a, b, c, d, e and f represents pads on RPCB and a′, b′, c′, d′, e′ and f′ represents pads on FPCB. The trace lengths between a-a′, b-b′ . . . are measured with a ruler and are recorded in the second column. The electrical resistances between a-a′, b-b′ . . . are recorded in the third column. Plotting the resistance versus conductive trace length yields a result shown in FIG. 4. Applying linear regression over these data generates nearly perfect fit with correlation coefficient reaching 0.998, indicating very high reliability. Extrapolating this line to zero-trace length, i.e. intercept at y-axis, gives the actual contact resistance of ACA-film which is only 0.024 Ω in FIG. 4, a very low resistance indeed.

Also shown in Table 2 is a parameter denoted as contact impedance which is obtained by multiplying the value of contact resistance (0.024 Ω) by the contact area (0.002 cm²) of the conductive trace, and it is shown to be 4.8×10⁻⁵ Ω·cm². The contact area is obtained by multiplying the width of the conductive trace (0.01 cm) by the width of the hot-bar (0.2 cm), hence 0.002 cm². This contact impedance is speculated to be an intrinsic value for any given ACA composition. It should remain the same regardless of the contact area. The contact resistance, on the other hand, should be inversely proportional to contact area, i.e. the larger the contact area and the smaller the contact resistance. This relationship can be expressed mathematically as:

R=σ/A

where R: contact resistance (Ω)
σ. contact impedance (Ω·cm².)
A: area (cm²)

TABLE 2
ACA - hot-bar @ 85° C. × 3 minutes

| | |
|---|---|
| coating width: | 0.2 cm |
| A (contact area): | 0.002 cm² |
| R (contact | 0.024 Ω |
| resistance): | |
| σ (contact | 4.8E−05 Ω · cm² |
| Impedance): | |

| | trace length | |
|---|---|---|
| pad | (mm) | R (Ω) |
| a-a′ | 57 | 0.55 |
| b-b′ | 76 | 0.74 |
| c-c′ | 95 | 0.89 |
| d-d′ | 114 | 1.06 |
| e-e′ | 131 | 1.22 |
| f-f′ | 153 | 1.45 |

Contact resistances derived from extrapolation are also listed in Table 1. Their values are all below 0.1Ω, which is very good for all practical purposes. The peel strength for these compositions are all greater than 0.5 kgf/cm, which is satisfactory for most applications.

Those skilled in the art will readily observe that numerous modifications and alterations of the device and method may be made while retaining the teachings of the invention.

What is claimed is:

1. A composition of ambient-curable anisotropic conductive adhesive, comprising:
A conductive powder dispersed in.
an ambient-curable epoxy resin system

2. The composition of the ambient-curable anisotropic conductive adhesive according to claim 1, wherein the conductive powder is a filamentary or flake nickel powder. The weight percentage of the conductive powder, relative to the total weight of the mixture, is in the range of 1-10%.

3. The composition of the ambient-curable anisotropic conductive adhesive according to claim 1, wherein the ambient-curable epoxy resin system comprising an epoxy resin or a blend of epoxy resins selected from a group of liquid epoxy resin consisting of Bisphenol-A, Bisphenol-F, Phenolic, Novolac, and flexibilized epoxy resins.

4. The composition of the ambient-curable anisotropic conductive adhesive according to claim 1 further comprising common ambient-curable hardener of modified amines or polyamides.

5. The composition of the ambient-curable anisotropic conductive adhesive according to claim 1 may optionally contain additives such as de-foamers and thixotropic reagents.
